(19) United States
(12) Patent Application Publication
(10) Pub. No.: US 2007/0291806 A1
(43) Pub. Date: Dec. 20, 2007

(54) VARIABLE RESISTANCE CIRCUIT AND LIGHT SOURCE CONTROL DEVICE USING THE SAME

(76) Inventor: YU-BING ZHOU, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(21) Appl. No.: 11/615,901

(22) Filed: Dec. 22, 2006

(30) Foreign Application Priority Data
Jun. 2, 2006 (CN) 200610060954.7

(51) Int. Cl. H01S 3/13

(52) U.S. Cl. 372/38.02; 372/30

(57) ABSTRACT

A variable resistance circuit comprises an input terminal, an output terminal, and a variable resistance module. The variable resistance is connected between the input terminal and the output terminal. The variable resistance module comprises a resistance network including at least one resistor and an interface including a plurality of contacts. Some of the contacts are electrically connected to the resistance network and the others are electrically connected to the input terminal and the output terminal. A light source control device is also disclosed.

### BACKGROUND OF THE INVENTION

1. Field of the Invention

The present invention generally relates to a light source control device, and more particularly to a variable resistance circuit of light source control device.

2. Description of Related Art

Generally, an optical disk drive reproduces data recorded on the optical disk and records data on a recording medium such as an optical disk. The optical disk drive typically includes a light source for emitting a light beam, an optical system for focusing the light beam onto the optical disk and receiving a reflected light beam from the optical disk, and a detector for receiving and interpreting the reflected light beam in electronic signals.

An optical power of the light source is an important factor to the reproduction quality and the record quality of the optical disk drive. In practice, the light source of the optical disk drive is adjusted to get an optimal optical power before the optical disk drive is put into the market. A typical method for adjusting the optimal optical power changes a resistance of the light source to control a current passing through the light source.

Referring to FIG. 11, a resistance variable circuit 10 is employed in a traditional control circuit (not shown) for a light source. The resistance variable circuit 10 includes an input terminal 12, a stable resistor R11, a variable resistor R12, and an output terminal 14. A resistance of the resistance variable circuit 10 can be adjusted by adjusting a resistance of the variable resistor R12 to obtain an optimal current applied to the light source. Usually, the resistance of the variable resistor R12 is adjusted by rotating a knob.

However, a sliding contact in the variable resistor R12 may wear out over time by a rotation of the knob. When the sliding contact wears out, it becomes a bad contact, and the resistance of the adjustable resistor R12 is unstable, thus an unstable light beam will be emitted from the light source. As a result, a reproduction quality and a record quality of the optical disk drive are badly affected.

Therefore, a variable resistance circuit of a light source control device is needed in the industry to address the aforementioned deficiencies and inadequacies.

### SUMMARY OF THE INVENTION

A variable resistance circuit comprises an input terminal, an output terminal, and a variable resistance module. The variable resistance is connected between the input terminal and the output terminal. The variable resistance module comprises a resistance network including at least one resistor and an interface including a plurality of contacts. Some of the contacts are electrically connected to the resistance network and the others are electrically connected to the input terminal and the output terminal. A light source control device is also disclosed.

Other systems, methods, features, and advantages of the present variable resistance circuit and a present light source control device will be or become apparent to one with skill in the art upon examination of the following drawings and detailed description. It is intended that all such additional systems, methods, features, and advantages be included within this description, be within the scope of the present device, and be protected by the accompanying claims.

### BRIEF DESCRIPTION OF THE DRAWINGS

Many aspects of the present variable resistance circuit and the present light source control device can be better understood with reference to the following drawings. The components in the drawings are not necessarily to scale, emphasis instead being placed upon clearly illustrating the principles of the present device. Moreover, in the drawings, like reference numerals designate corresponding parts throughout the several views.

FIG. 1 is a block diagram showing a variable resistance circuit in accordance with an first exemplary embodiment;

FIG. 2 is a circuit diagram of the variable resistance circuit of FIG. 1;

FIG. 3 is a table showing values of resistances of the variable resistance circuit of FIG. 2;

FIG. 4 is a circuit diagram of the variable resistance circuit in accordance with a second exemplary embodiment;

FIG. 5 is a table showing additional values of resistances of the variable resistance circuit of FIG. 4 based on the values in the table of FIG. 3;

FIG. 6 is a circuit diagram of the variable resistance circuit in accordance with a third exemplary embodiment;

FIG. 7 is a table showing values of resistances of the variable resistance circuit of FIG. 6;

FIG. 8 is a circuit diagram of the variable resistance circuit in accordance with a fourth exemplary embodiment;

FIG. 9 is a table showing values of resistances of the variable resistance circuit of FIG. 8;

FIG. 10 is a circuit diagram of a light source control device using the variable resistance circuit of FIG. 1; and

FIG. 11 is a circuit diagram of a traditional control circuit.

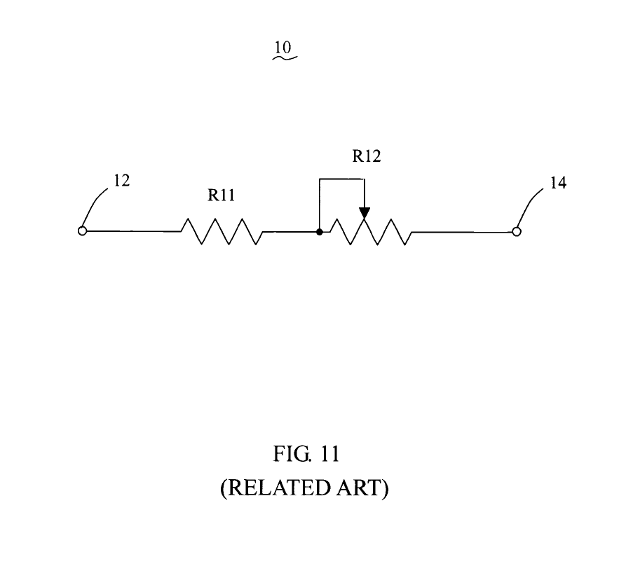

### DETAILED DESCRIPTION OF THE INVENTION

Reference will now be made to the drawings to describe a preferred embodiment of the present variable resistance circuit.

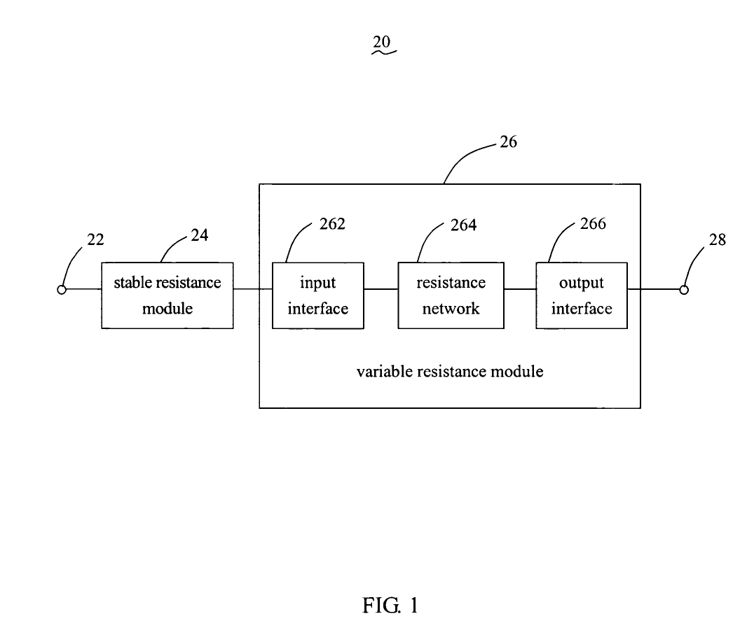

Referring to FIG. 1, a variable resistance circuit 20 in accordance with a first exemplary embodiment includes an input terminal 22, a stable resistance module 24, a variable resistance module 26, and an output terminal 28 electrically connected in series in an order described. A resistance of the variable resistance circuit 20 is adjustable by adjusting a resistance of the variable resistance module 26.

The variable resistance circuit 20 can be used in a light source control device, with the input terminal 22 and the output terminal 28 connected to the light source control device. The stable resistance module 24 contains at least one resistor.

The variable resistance module 26 includes an input interface 262, a resistance network 264, and an output interface 266. The input interface 262 and the output interface 266 include contacts, and further, the contacts can be electrically connected to each other within the interface to obtain various resistance values of the resistance network 264.

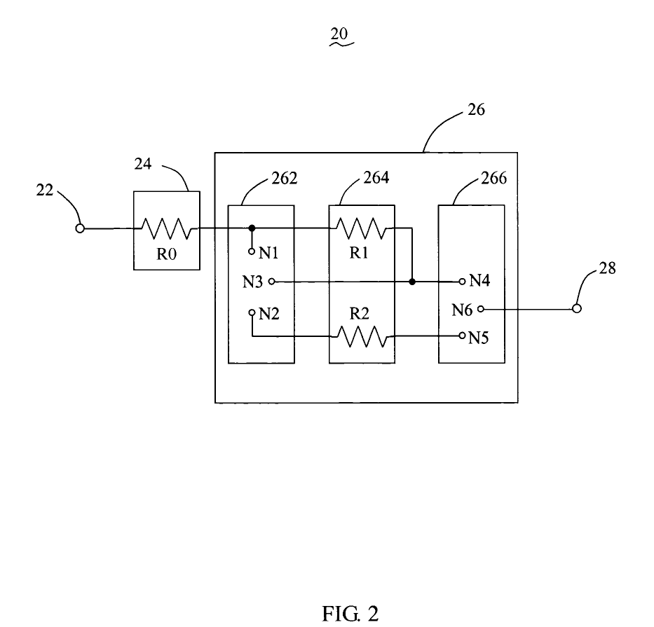

Referring to FIG. 2, the stable resistance module 24 is a basic resistor R0 used for providing a lower bound resistance of the variable resistance circuit 20. The input interface 262 includes a first contact N1, a second contact N2, and a third contact N3. The first contact N1, the second contact N2, and the third contact N3 can be electrically connected to each other. The output interface 266 includes a fourth contact N4, a fifth contact N5, and a sixth contact N6. The contact N4, the fifth contact N5, and the sixth contact N6 also can be electrically connected to each other. The resistance network 264 includes a first resistor R1 and a second resistor R2.

The input terminal 22, the basic resistor R0, the first contact N1, the first resistor R1, and the fourth contact N4 are electrically connected in series. The third contact N3 is electrically connected to the fourth contact N4. An end of the second resistor R2 is electrically connected to the second contact N2, and another end of the second resistor R2 is electrically connected to the fifth contact N5. The output terminal 28 is electrically connected to the sixth contact N6.

When various connections are used to aforementioned contacts of the input interface 262 and the output interface 266, the resistance of the variable resistance circuit 20 is adjusted. For example, when there is no connections between the contacts in the first interface 262, and the fourth contact N4 is electrically connected to the sixth contact N6 in the output interface 266, the first resistor R1 is electrically connected between the input terminal 22 and the output terminal 28. When the first contact N1 is electrically connected to the second contact N2 in the first interface 262, and the fourth contact N4 and the fifth contact N5 are both electrically connected with the sixth contact N6 in the output interface 28, the first resistor R1 and the second resistor R2 are electrically connected in parallel and both connected between the input terminal 22 and the output terminal 28.

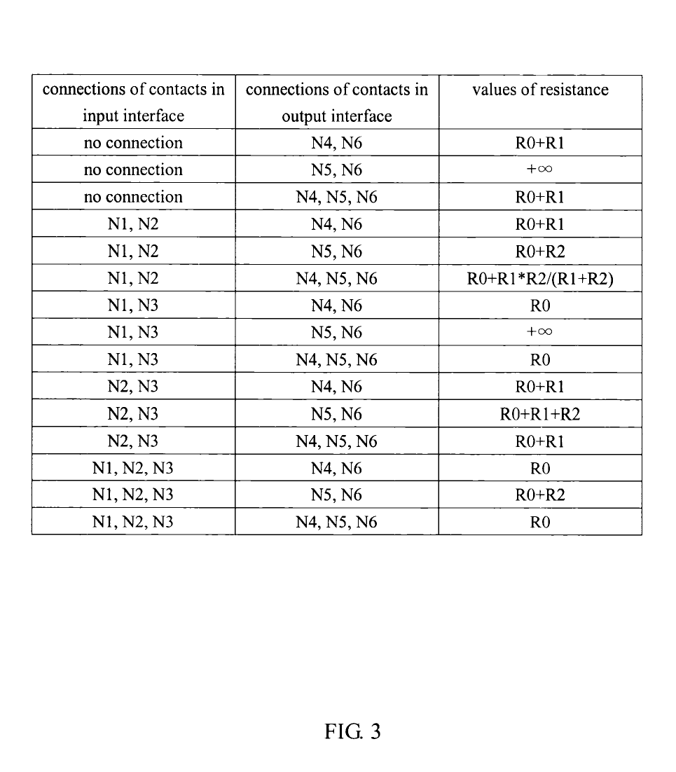

Referring to FIG. 3, a plurality of connections of the contacts and corresponding values of the resistance of the variable resistance circuit 20 is illustrated. There are five possible resistance values of the variable resistance circuit 20. The five values are R0, R0+R1*R2/(R1+R2), R0+R1, R0+R2, and R0+R1+R2, except for the infinitude. Accordingly, the light source using the variable resistance circuit 20 can obtain five values of power.

In practice, many methods, such as jointing and switching, can be used for electrically connecting the contacts. The resistance of the variable resistance circuit 20 can be adjusted by changing connections of the contacts. Since no adjustable resistors are used in the variable resistance circuit 20, there are no bad contacts. Furthermore, the variable resistance circuit 20 has a lower cost in comparison with a traditional control circuit using the adjustable resistor.

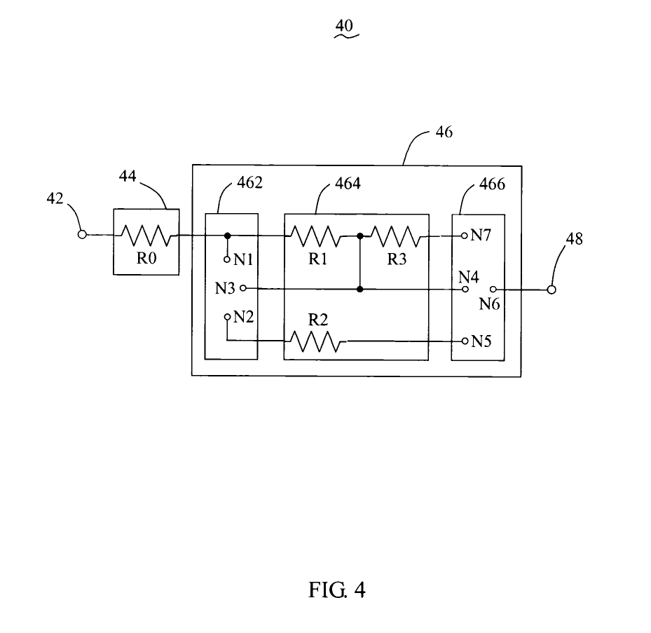

Referring to FIG. 4, a variable resistance circuit 40 in accordance with a second exemplary embodiment is illustrated. The variable resistance circuit 40 includes an input terminal 42, a stable resistance module 44, a variable resistance module 46, and an output terminal 48 electrically connected in series. The variable resistance module 46 includes an input interface 462, a resistance network 464, and an output interface 466. Compared with the variable resistance circuit 20 according to the first exemplary embodiment, the variable resistance circuit 40 includes an additional third resistor R3 and an additional seventh contact N7.

The input terminal 42, the basic resistor R0, the first contact N1, the first resistor R1, the third resistor R3, and the seventh contact N7 are electrically connected in series. The third contact N3 and the fourth contact N4 are electrically connected together, and both electrically connected to a first interconnection between the first resistor R1 and the third resistor R3. An end of the second resistor R2 is electrically connected to the second contact N2 and another end of the second resistor R2 is electrically connected to the fifth contact N5. The sixth contact N6 is connected to the input terminal 48.

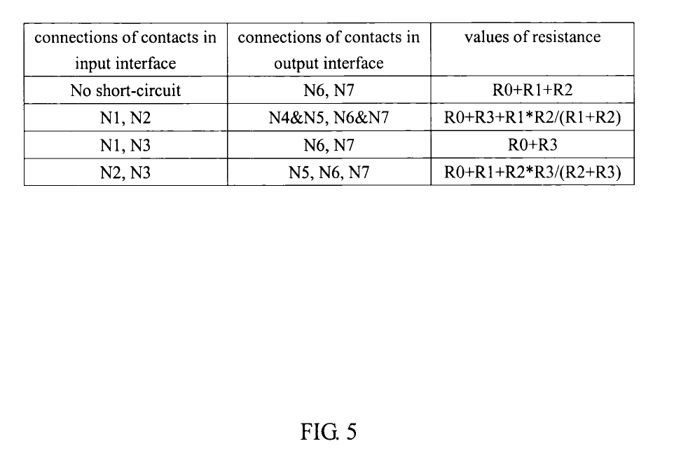

Referring to FIG. 3 and 5, since the variable resistance circuit 40 completely adopts the variable resistance circuit 20, the values of the resistance of the variable resistance circuit 40 also contains R0, R0+R1*R2/(R1+R2), R0+R1, and R0+R2. Furthermore, because the variable resistance circuit 40 includes the third resistor R3 and the seventh contact N7, the resistance of the variable resistance circuit 40 further contains four other values. The four other values are R0+R3, R0+R1+R3, R0+R3+R1*R2/(R1+R2), and R0+R1+R2*R3/(R2+R3). That is, the light source using the variable resistance circuit 40 can obtain nine values of power.

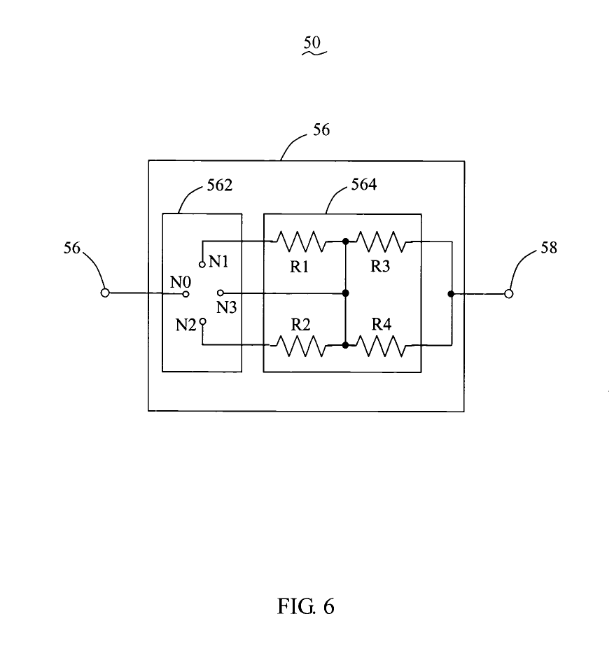

Referring to FIG. 6, a variable resistance circuit 50 in accordance with a third exemplary embodiment is illustrated. The variable resistance circuit 50 includes an input terminal 52, a variable resistance module 56, and an output terminal 58 electrically connected in series. The variable resistance module 56 includes an input interface 562 and a resistance network 564. Compared with the variable resistance circuit 40 according to the second exemplary embodiment, the variable resistance circuit 50 abolishes the basic resistor R0 and the output interface 466, and adds an input contact N0 and a fourth resistor R4.

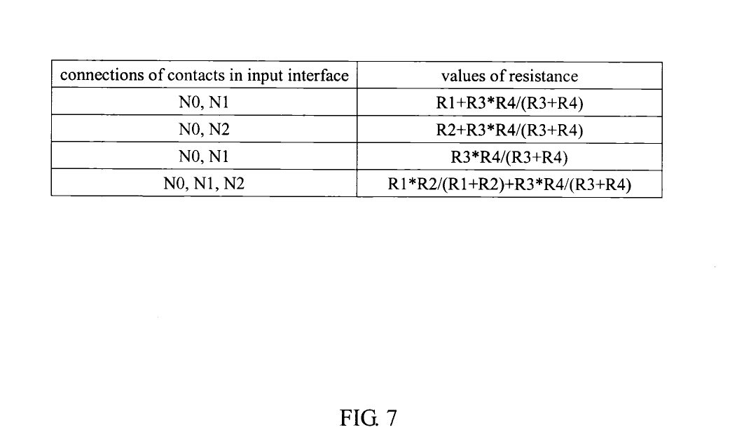

The input contact N0 is electrically connected to the input terminal 56, and can be connected to any one of the first contact N1, the second contact N2, and the third contact N3. The first contact N1, the first resistor R1, the third resistor R3, the fourth resistor R4, the second resistor R2, and the second contact N2 are electrically connected in series. The third contact N3 is electrically connected to a second interconnection between the first resistor R1 and the third resistor R3, and a third interconnection between the second resistor R2 and the fourth resistor R4. The output terminal 58 is electrically connected to a fourth interconnection between the third resistor R3 and the fourth resistor R4. Referring to FIG. 7, the resistance of the variable resistance circuit 50 contains four values.

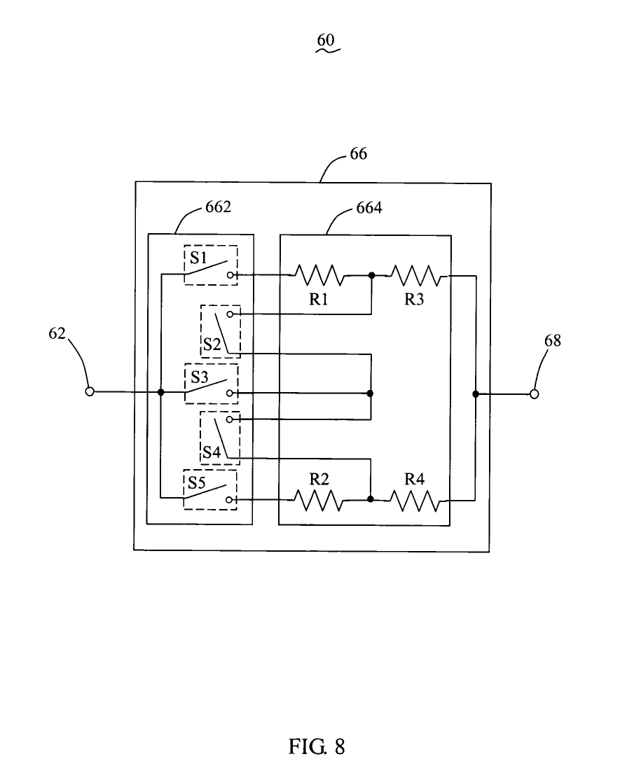

Referring to FIG. 8, a variable resistance circuit 60 in accordance with a fourth exemplary embodiment is illustrated. The variable resistance circuit 60 includes an input terminal 62, a variable resistance module 66, and an output terminal 68 electrically connected in series. The variable resistance module 56 includes an input interface 662 and a resistance network 664. Compared with the variable resistance circuit 50 according to the third exemplary embodiment, switches are used to controlling connections between contacts in the input interface 662.

The input interface 662 includes a first switch S1, a second switch S2, a third switch S3, a fourth switch S4, and a fifth switch S5. The first switch S1, the first resistor R1, and the third resistor R3 are electrically connected in series to construct a first series circuit. The fifth switch S5, the second resistor R2, and the fourth resistor R4 are electrically connected in series to construct a second series circuit. The first series circuit and the second series circuit are electrically connected in parallel to construct a parallel circuit, and the parallel circuit is electrically connected between the input terminal 62 and the output terminal 68. The second switch S2 and the fourth switch S4 are electrically connected in series, and between a fifth interconnection between the first resistor R1 and the third resistor R3 and a sixth interconnection between the second R2 and the fourth resistor R4. The third switch S3 is electrically connected between the input terminal 62 and a seventh interconnection between the second switch S2 and the fourth switch S4.

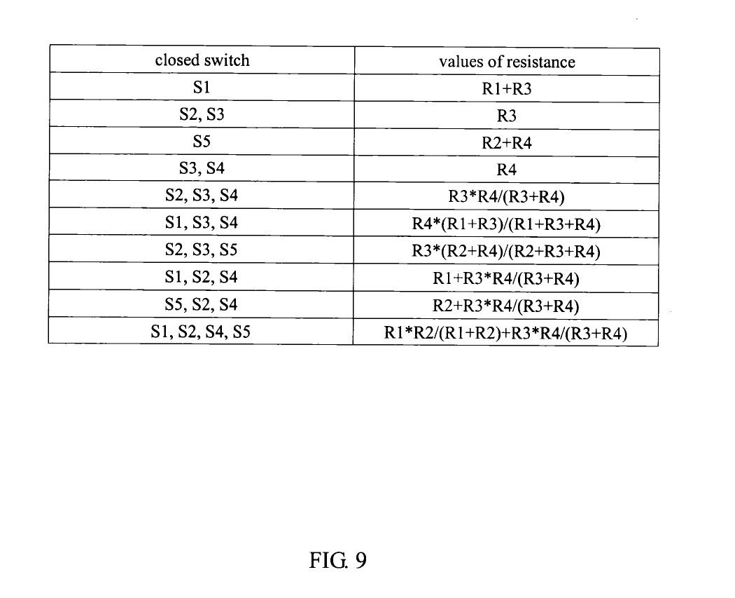

A value of the resistance of the variable resistance circuit 60 can be adjusted by adjusting states of the switches in the input interface 662. Referring to FIG. 9, the resistance of the variable resistance circuit 60 contains ten values.

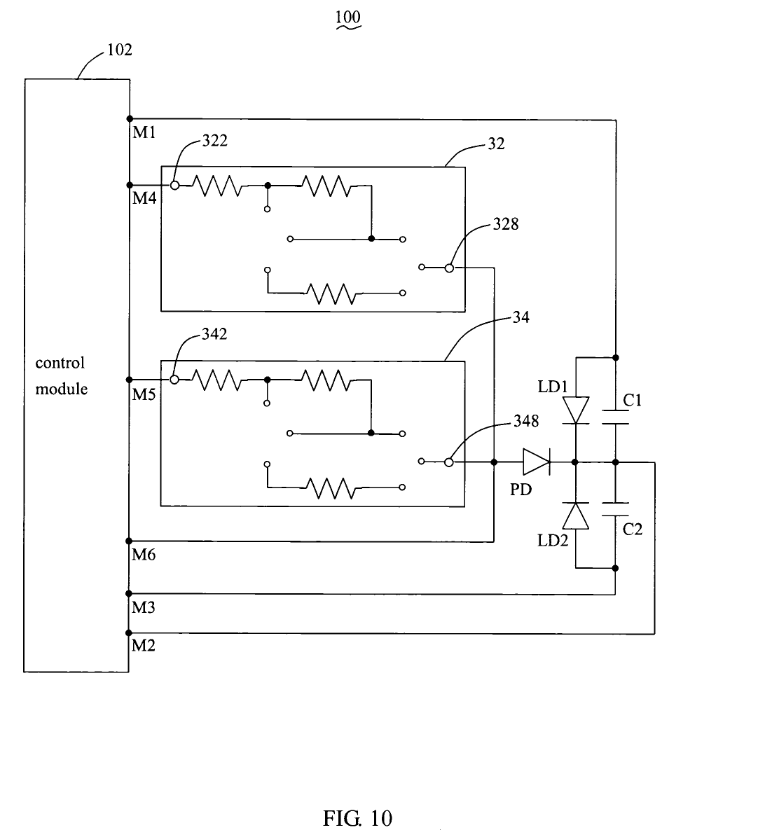

Referring to FIG. 10, a light source control device 100 according to a first exemplary embodiment can be used to control light sources of CD (compact disk) drivers and DVD (digital versatile disk) drivers. The light source control device 100 includes a first variable resistance circuit 32, a second variable resistance circuit 34, a control module 102, a first light source LD1, a second light source LD2, a photosensitive member PD, a first capacitor C1, and a second capacitor C2. In the embodiment, both the first variable resistance circuit 32 and the second variable resistance circuit 34 adopt a same structure of aforementioned variable resistance circuit 20.

An anode and a cathode of the first light source LD1 are electrically connected to a first node M1 and a second node M2 of the control module 102 respectively. The first light source LD1 and the first capacitor C1 are connected in parallel between the first node M1 and the second node M2. An anode and a cathode of the second light source LD2 are electrically connected to a third node M3 and the second node M2 of the control module 102 respectively. The second light source LD2 and the second capacitor C2 are electrically connected in parallel between the second node M2 and the third node M3. The input terminal 322 of the first variable resistance circuit 20 and the input terminal 324 of the second variable resistance circuit 20 are electrically connected to a fourth node M4 and a fifth node M5 of the control module 102 respectively, and the output terminal 328 of the first variable resistance circuit 20 and the output terminal 348 of the second variable resistance circuit 20 are both electrically connected to an anode of the photosensitive member PD. A cathode of the photosensitive member PD is electrically connected to the second node M2. Furthermore, the anode of the photosensitive member PD is also electrically connected to a sixth node M6 of the control module 102.

When the light source control device 100 is used, the control module 102 supplies power to the first light source LD1 via the first node M1. Simultaneously, the third node M3 and the fifth node M5 are off. The first light source LD1 emits a light beam. The photosensitive member PD receives the light beam and generates a corresponding first electrical signal, such as a current. Correspondingly, a voltage of the first variable resistance circuit 32 is generated as the fist electrical signal passes through the first variable resistance circuit 32. Additionally, the voltage can be adjusted by changing connections of the contacts in the input interface 262 and the output interface 264, in order to adjust a second electrical signal sent to the control module 102, such as a voltage sent to the sixth node M6. The control module 102 adjusts a power of the first light source LD1 via the second electrical signal. The first capacitor C1 is used for filtering out noise.

When the light source control device 100 is used to control light source of DVD, the control module 102 supplies power to the first light source LD2. The second variable resistance circuit 34 is used for adjusting the second electrical signal. The control module 102 adjusts a power of the first light source LD2 via the second electrical signal.

In a preferred practice, the second node M2 is typically connected to ground, and the fourth node M4 is typically connected to a constant power source. In the preferred practice, the first light source LD1 projects a light beam with a 780 nm wavelength, and the second projects a light beam with a 650 nm wavelength. Furthermore, the variable resistance circuit 40, 50, and 60 can also be used for the variable resistance circuit 32 and 34 in the light source control device 100.

It should be emphasized that the above-described preferred embodiment, is merely a possible example of implementation of the principles of the invention, and is merely set forth for a clear understanding of the principles of the invention. Many variations and modifications may be made to the above-described embodiment of the invention without departing substantially from the spirit and principles of the invention. All such modifications and variations are intended to be included herein within the scope of this disclosure and the present invention and be protected by the following claims.

What is claimed is:

1. A variable resistance circuit comprising:
an input terminal;
an output terminal;
a variable resistance module being electrically connected between the input terminal and the output terminal, the variable resistance module comprising:
a resistance network comprising at least one resistor; and
an interface comprising a plurality of contacts, wherein a predetermined number of the contacts are electrically connected to the resistance network and another predetermined number of the contacts are electrically connected to the input terminal and the output terminal.

2. The variable resistance circuit according to claim 1, wherein the interface comprises an input interface electrically connected to the input terminal and an output interface electrically connected to the output terminal.

3. The variable resistance circuit according to claim 2, wherein the resistance network comprises a first resistor and a second resistor, and the input interface comprises a first contact electrically connected to one end of the first resistor, a second contact electrically connected to one end of the second resistor, and a third contact electrically connected to the other end of the first resistor, and the output interface comprises a fourth contact electrically connected to the other end of the first resistor, a fifth contact electrically connected to the other end of the second resistor, and a sixth contact electrically connected to the output terminal.

4. The variable resistance circuit according to claim 3, wherein the variable resistance circuit comprises a stable resistance module electrically connected between the input terminal and the first contact.

5. The variable resistance circuit according to claim 4, wherein the stable resistance module comprises a basic resistor for proving a lower bound resistance of the variable resistance module.

6. The variable resistance circuit according to claim 5, wherein the variable resistance circuit comprises a third resistor, and one end of the third resistor is electrically connected to the other end of the first resistor.

7. The variable resistance circuit according to claim 6, wherein the variable resistance circuit comprises a seventh contact electrically connected to the other end of the third resistor.

8. The variable resistance circuit according to claim 1, wherein the interface comprises an input interface electrically connected to the input terminal, and the input interface comprises an input contact electrically connected to the input terminal, a first contact, a second contact and a third contact.

9. The variable resistance circuit according to claim 8, wherein the variable resistance circuit comprises a first resistor electrically connected between the first contact and the third contact, a second resistor electrically connected between the second contact and the third contact, a third resistor electrically connected between the third contact and the output terminal, and a fourth resistor electrically connected between the third contact and the output terminal.

10. The variable resistance circuit according to claim 9, wherein the variable resistance comprises a plurality of switches for controlling connections between the contacts.

11. A light source control device comprising:
a light source for projecting a light beam;
a control module for controlling an optical power of the light source based on an adjustable resistance; and
a variable resistance module for providing the adjustable resistance, the variable resistance module comprising a resistance network for providing at least one resistor and an interface comprising a plurality of contacts, with a predetermined number of the contacts electrically connected to the resistance network and another predetermined number of the contacts electrically connected to the light source and the control module;
wherein connections between the contacts can be changed to adjust the adjustable resistance.

12. The light source control device according to claim 11, further comprising a photosensitive member for generating a first electrical signal.

13. The light source control device according to claim 12, wherein the variable resistance module is for adjusting connections of the contacts to adjust a second electrical signal sent to the control module based on the first electrical signal.

14. The light source control device according to claim 13, wherein the interface comprises an input interface electrically connected to the control module and an output interface electrically connected to the light source.

15. The light source control device according to claim 14, wherein the resistance network comprises a first resistor and a second resistor, and the input interface comprises a first contact electrically connected to one end of the first resistor, a second resistor electrically connected to one end of the second resistor, and a third resistor electrically connected to the other end of the first resistor, and the output interface comprises a fourth contact electrically connected to the other end of the first resistor, a fifth contact electrically connected to the other end of the second resistor, and a sixth contact electrically connected to the light source.
